(19) United States
(12) Patent Application Publication
(10) Pub. No.: US 2013/0110952 A1
(43) Pub. Date: May 2, 2013

(54) MANAGING VIRTUAL UNIVERSE AVATAR BEHAVIOR RATINGS

(71) Applicant: International Business Machines Corporation, Armonk, NY (US)

(72) Inventors: Christopher J. Dawson, Arlington, VA (US); Vincent V. Diluoffo, Sandy Hook, CT (US); Michael D. Kendzierski, New York, NY (US)

(73) Assignee: INTERNATIONAL BUSINESS MACHINES CORPORATION, Armonk, NY (US)

(21) Appl. No.: 13/717,241

(22) Filed: Dec. 17, 2012

Related U.S. Application Data
(63) Continuation of application No. 12/236,321, filed on Sep. 23, 2008.

(51) Int. Cl. G06Q 10/00

(52) U.S. Cl. CPC G06Q 10/00
USPC 709/206

(57) ABSTRACT

Inappropriate behavior, such as harassment, expletive laden communications, violence or sexually explicit behavior in a virtual universe (VU) can lead to negative experiences for VU users. Younger users of a VU can be more susceptible to inappropriate behavior than adult users. A VU system can monitor behavior and associate behavior ratings with avatars within the VU to respond to avatar/user behavior. A system can determine behavior ratings based upon avatar interactions, user complaints or complements about an avatar, actions within the VU, etc. The system can subject poorly behaving avatars to various penalties (e.g., restriction from certain areas, account termination, etc.). The system can also reward avatars that exhibit good behavior (e.g., allowing access to bonus areas or content, awarding points that can be used as VU currency, etc.). Penalizing inappropriate behavior and rewarding positive behavior can increase safety of minors in the VU, and increase user experience overall.

### RELATED APPLICATIONS

This application is a continuation application that claims benefit of U.S. application Ser. No. 12/236,321 filed Sep. 23, 2008.

### BACKGROUND

Embodiments of the inventive subject matter generally relate to the field of virtual universe systems, and, more particularly, to managing virtual universe avatar behavior ratings.

Virtual universe applications allow people to socialize and interact in a virtual universe. A virtual universe (VU) is a computer-based simulated environment intended for its residents to traverse, inhabit, and interact through the use of avatars. Many VUs are represented using 3-D graphics and landscapes, and are populated by many thousands of users, known as residents. Other terms for VUs include metaverses and “3D Internet.” Virtual universes, such as Second Life, are growing at a substantial rate. As the number of users of a VU increases, the likelihood of misbehavior within the VU also increases. Inappropriate behavior, such as harassment, violence or sexually explicit behavior in a virtual universe can lead to negative experiences for VU users. The impact of inappropriate behavior may be much greater on younger users in the VU.

### SUMMARY

Embodiments include a method directed to determining that a behavior rating of an avatar should be updated. A behavior score is determined from a behavior scale. The behavior rating of the avatar is updated with the behavior score.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example conceptual diagram of a behavior rating system in a virtual universe.

FIG. 2 is a flowchart depicting example operations for updating an avatar's behavior rating.

FIG. 3 is a flowchart depicting example operations for updating an avatar's behavior rating based on detecting a behavior performed by the avatar.

FIG. 4 depicts an example conceptual diagram of limiting access to an area in the virtual universe based on behavior ratings.

FIG. 5 is a flowchart depicting example operations for limiting access to areas within a virtual universe based on behavior ratings.

FIG. 6 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to virtual universes, embodiments can be implemented in massive multiplayer online role-playing games (MMORPG). In other instances, well-known instruction instances, protocols, structures and techniques have not been shown in detail in order not to obfuscate the description.

Inappropriate behavior, such as harassment, expletive laden communications, violence or sexually explicit behavior in a virtual universe (VU) can lead to negative experiences for VU users. Younger users of a VU can be more susceptible to inappropriate behavior than adult users. A VU system can monitor behavior and associate behavior ratings with avatars within the VU to respond to both positive and negative avatar/user behavior. A system can determine behavior ratings based upon avatar interactions, user complaints or complements about an avatar, actions within the VU, etc. The system can subject poorly behaving avatars to various penalties (e.g., restriction from certain areas within the VU, account termination if misbehavior reaches certain thresholds, etc.). The system can also reward avatars that exhibit good behavior (e.g., allowing access to bonus areas or content in the VU, awarding points that can be used as currency in the VU, etc.). Penalizing inappropriate behavior and rewarding positive behavior can increase safety of minors in the VU, as well as increase user experience overall.

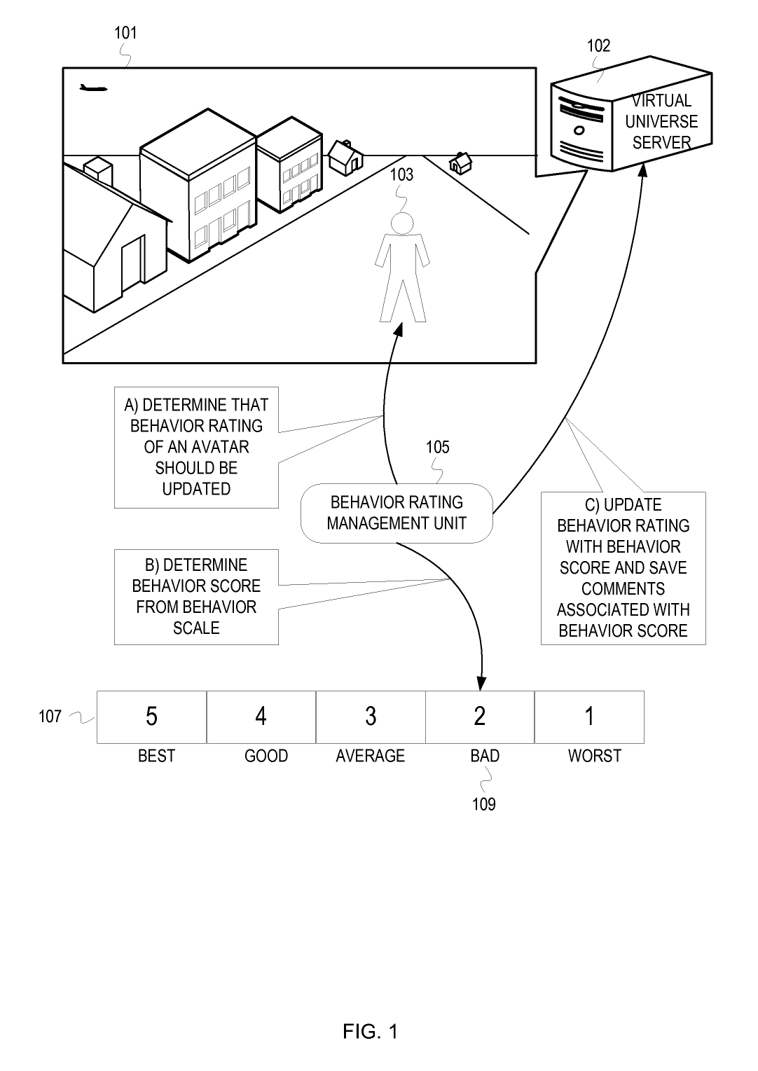

FIG. 1 depicts an example conceptual diagram of a behavior rating system in a virtual universe. A perspective 101 of a virtual universe is supported by a virtual universe server 102 and includes various graphical objects (e.g., buildings, avatars, vehicles, etc.) that make up the perspective 101. An avatar 103 is instantiated in virtual universe 101.

At stage A, a behavior rating management unit 105 determines that a behavior rating of the avatar 103 should be updated. A behavior rating is an overall indication of an avatar's behavior in the VU. Determining that an avatar's behavior rating should be updated may be based on manual indication by a user. For example, a user clicks a rate interaction button to indicate that he or she would like to rate the behavior of an avatar. Determining that an avatar's behavior rating should be updated may be automatic based on detection of certain behaviors. For example, a VU detects that a male avatar entered a women's restroom. A negative behavior score is associated with this behavior, so the avatar's behavior rating is lowered. The behavior rating management unit may also determine the gender of the avatar's user because users can create and use avatars of either gender.

At stage B, the behavior rating management unit 105 determines a behavior score 109 from a behavior scale 107. The behavior score 109 may be manually indicated by a user or may be predefined based on the type of behavior exhibited by the avatar 103. FIG. 1 depicts a 5 point behavior scale, but the behavior scale 107 may be based on any number of points. In this case, the behavior score 109 is “2 out of 5.” Weights may be associated with different levels of behavior on the behavior scale 107. Comments about the behavior of avatar 103 may be associated with the behavior score 109. Comments may be entered by the user providing the behavior score 109 or may be default text describing a behavior detected by the VU.

At stage C, the behavior rating management unit 105 updates the behavior rating of the avatar 103 with the behavior score 109 and saves any comments associated with the behavior score 109. Updating the behavior rating of the avatar 103 comprises updating at least one of a sum, an average, a median and a standard deviation with the behavior score 109. The average may be an arithmetic average or a weighted average over a period of time or for a certain number of most recent behavior scores. Different weights may be associated with different behavior scores. For example, a behavior score submitted by a VU administrator may be given a higher weight than a behavior score submitted by a regular user. As another example, a behavior score submitted by a user whose avatar has a high behavior rating may be weighted higher than a user whose avatar has a lower behavior rating.

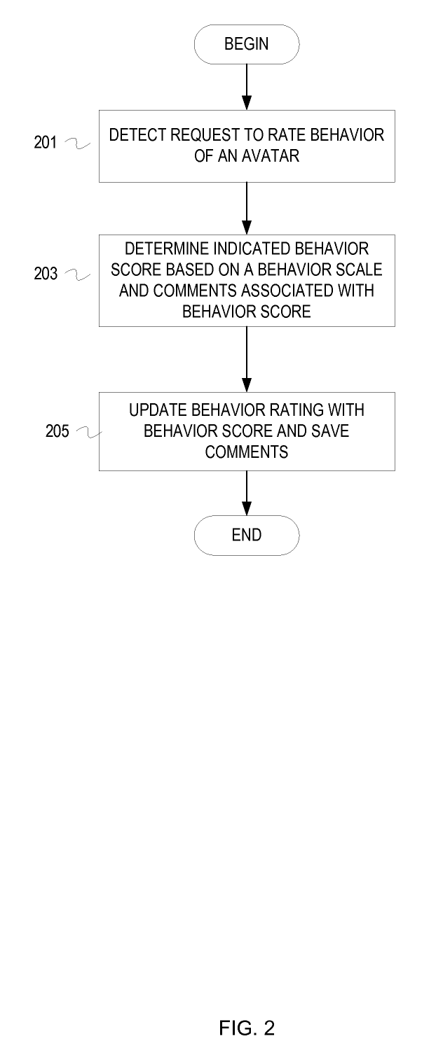

FIG. 2 is a flowchart depicting example operations for updating an avatar's behavior rating. Flow begins at block 201, where a request to rate a behavior of an avatar is detected. For example, a first avatar asks a second avatar for directions to a store in the VU. Instead of giving verbal directions, the second avatar walks the first avatar to the store. A user of the first avatar indicates a desire to submit a good rating for the second avatar by clicking a rate interaction button. The opportunity to rate the behavior of an avatar in the virtual universe is not limited to interactions between avatars. A user can rate the behavior of an avatar after witnessing actions of the avatar. For example, a user witnesses an avatar deface a wall. The user indicates a desire to submit a bad rating for the avatar by clicking a report behavior button.

At block 203, an indicated behavior score based on a behavior scale and comments associated with the behavior score are determined. A user may indicate a behavior score by clicking a radio button in a scale, typing a number within a range into a text box, etc. A user may or may not submit comments along with the behavior score when rating an avatar.

At block 205, the avatar's behavior rating is updated with the behavior score and comments associated with the behavior score are saved. In some embodiments, a user may submit a behavior score anonymously. When the behavior rating is updated, no information that could identify a user's avatar is saved when the user chooses to remain anonymous. Allowing users to rate avatars anonymously alleviates fear of retaliation which may lead to more honest behavior scores. If the behavior rating is based on a weighted average, anonymous scores may have a different weight than scores submitted with identifying information. Comments may also be used to weight the behavior score. As an example, detection of certain words and frequency of those words within the comments may cause the score to be weighed higher or lower. Detection of curse words, for instance, would result in a lower weight for the behavior score and the behavior score may be subject to removal so it would not impact the behavior rating at all. As another example, grammar errors and typos may lead to a lower weight for a particular behavior score.

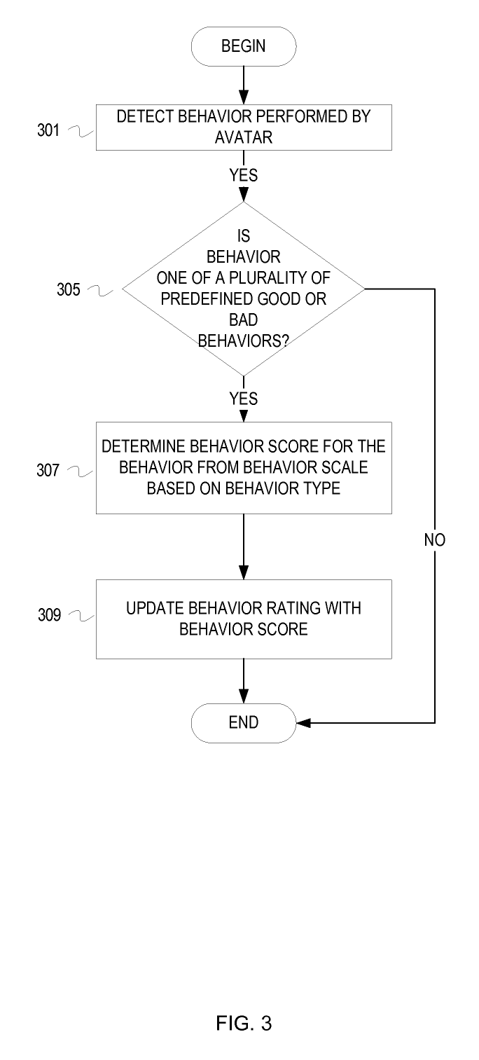

In addition to allowing users to rate avatar behavior, the virtual universe may detect good or bad behaviors and automatically update an avatar's behavior rating based on the type of behavior detected. FIG. 3 is a flowchart depicting example operations for updating an avatar's behavior rating based on detecting a behavior performed by the avatar. Flow begins at block 301, where a behavior performed by an avatar is detected. Examples of behaviors include touching an object, changing an object, walking, etc.

At block 305, it is determined if the behavior is one of a plurality of predefined good or bad behaviors. Examples of good behaviors include cleaning up trash in a public area, recycling, giving to charity, etc. Examples of bad behaviors include cursing, destroying property, spamming, etc. Determining if the behavior is a predefined behavior comprises at least one of matching an avatar's movement pattern to a predefined behavior movement pattern, monitoring chat and voice conversations for keywords, detecting a change in the properties or state of an object by an avatar that does not own the object, etc. In this example, behaviors of all avatars in the virtual universe are analyzed to determine if the behavior is one of a plurality of predefined good or bad behaviors. In another example, the behaviors of a subset of avatars in the virtual universe are analyzed. If an avatar's behavior rating decreases below a minimum acceptable behavior rating threshold (e.g., the avatar's behavior rating drops below 2 on a 5 point behavior scale), the avatar is subject to surveillance within a virtual universe. Selective surveillance allows the server to focus virtual universe server resources on avatars that are likely to engage in inappropriate behavior. Since the virtual universe can detect both good and bad behaviors, users have an opportunity to improve behavior ratings of their avatars that are under surveillance.

At block 307, a behavior score for the behavior is determined from a behavior scale based on the type of behavior. For example, good behaviors result in improved behavior scores and bad behaviors result in degraded behavior scores.

At block 309, the avatar's behavior rating is updated with the behavior score. The avatars behavior rating may be a sum of positive and negative scores, an arithmetic average, a weighted average, etc. In some embodiments, comments may be left indicating the specific behavior that lead to the behavior score being included in the avatar's behavior rating.

Behavior ratings allow a virtual universe to reward good virtual universe citizens and punish bad virtual universe citizens. Avatars that engage in good behaviors and maintain high behavior ratings may be rewarded with incentives in the virtual universe. These incentives may include access to bonus areas in the virtual universe, access to bonus content (e.g., eBooks, music downloads, etc), citizenship awards, etc. Avatars that engage in bad behaviors and have low behavior ratings may be subject to punishment in the virtual universe. The severity of punishment depends on certain thresholds and can range from restriction from access to certain areas in the virtual universe, restriction from owning certain items, suspension or termination of the avatar's account, observation by a virtual universe administrator, etc.

In some embodiments, other factors such as age, gender, national origin, etc. may influence an avatars behavior rating. For example, a bad behavior may not lower a behavior rating of a younger user's avatar as much as the same behavior would lower a behavior rating of an older user's avatar. As another example, a hand gesture may be viewed as offensive in one country, but not in another. A virtual universe detects a hand gesture performed by an avatar and determines that the gesture may be offensive. The virtual universe determines the national origin of the avatar to determine if the culture of the avatar's user indicates that the gesture is offensive. If the gesture is considered offensive, the avatars receives a bad behavior score that lowers the avatar's behavior rating. If the gesture is not considered offensive, the behavior does not result in the avatar receiving a behavior score so the avatar's behavior rating remains unchanged. Because a user can create an avatar with different age, gender or other characteristics different from the user's own characteristics, the virtual universe can examine user characteristics along with or instead of avatar characteristics when determining a behavior rating.

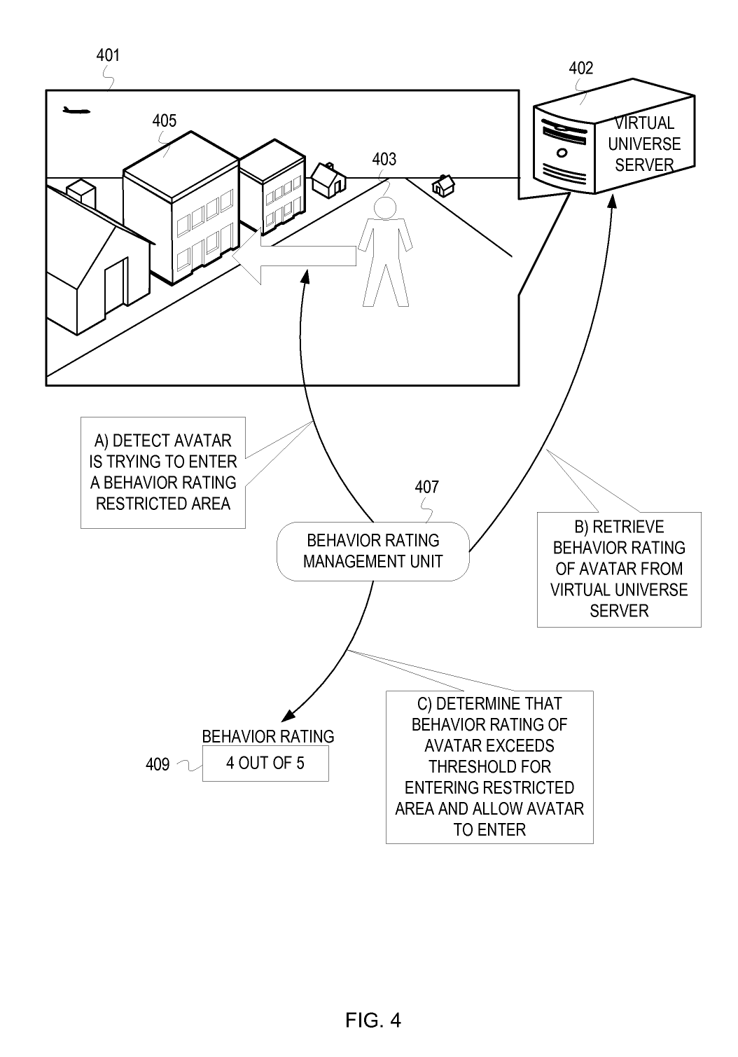

FIG. 4 depicts an example conceptual diagram of limiting access to an area in the virtual universe based on behavior ratings. A perspective 401 of a virtual universe is supported by a virtual universe server 402 and includes various graphical objects (e.g., buildings, avatars, vehicles, etc.) that make up the perspective 401. An avatar 403 is instantiated in virtual universe 401. A building 405 exists within the perspective 401.

At stage A, a behavior rating management unit 407 detects that the avatar 403 is trying to enter the building 405 that is a behavior rating restricted area. A behavior rating restricted area is an area in the virtual universe that can only be accessed by avatars that have behavior ratings that exceed certain thresholds. Thresholds for entering restricted areas may be different for different groups of avatars. For example, a behavior restricted area may comprise a children's playground. A first threshold is defined for avatars whose users are under 12 years old and a second threshold is defined for avatars whose users are over 12 years old. The second threshold corresponds to a higher minimum behavior rating for avatars controlled by older users to protect children in the playground from possible inappropriate behavior.

At stage B, the behavior rating management unit 407 retrieves the behavior rating 409 of avatar 403 is from the virtual universe server 402.

At stage C, the behavior rating management unit 407 determines that the behavior rating 409 of the avatar 403 exceeds a threshold for entering the building 405 and allows the avatar 403 to enter. If the behavior rating 409 of the avatar 403 had been below the threshold for entering, the avatar 403 would have been denied entry to the building 405.

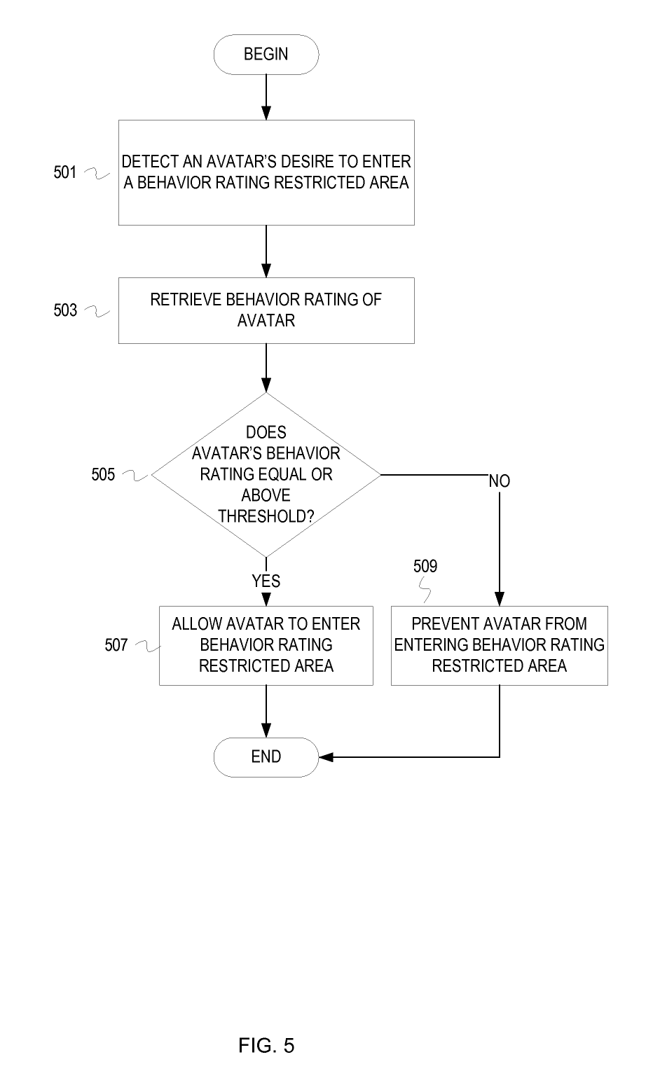

FIG. 5 is a flowchart depicting example operations for limiting access to areas within a virtual universe based on behavior ratings. Flow begins at block 501, where an avatar's desire to enter a behavior rating restricted area is detected. For example, an avatar tries to enter a lounge that serves as a bonus area for avatars whose behavior ratings exceed a high threshold.

At block 503, a behavior rating of the avatar is retrieved. The behavior rating may be stored on a server, in a local copy of the avatar's profile, etc.

At block 505, it is determined if the avatar's behavior rating is equal to or above a threshold. If the avatar's behavior rating is equal to or above the threshold, flow continues at block 507. If the avatar's behavior rating is less than the threshold, flow continues at block 509.

At block 507, the avatar is allowed to enter the behavior rating restricted area.

At block 509, the avatar is prevented from entering the behavior rating restricted area.

Although examples refer to behavior ratings that are based on a behavior scale, embodiments are not so limited. Other techniques may be utilized for rating avatar behavior. For example, an icon may be displayed above an avatar that indicates the behavior rating of the avatar. When the avatar receives a certain number of negative behavior ratings, a demerit may be depicted by the icon. When the avatar receives a certain number of positive behavior ratings, the icon may represent an honor badge. There may also be different icons associated with different numbers of behavior ratings received by an avatar. For instance, a more prestigious icon may be displayed for an avatar with 1000 positive behavior ratings than an avatar with 10 positive behavior ratings. The number of behavior ratings can be used to determine if an avatar should be able to gain access to behavior restricted areas or not.

It should be understood that the depicted flowcharts are examples meant to aid in understanding embodiments and should not be used to limit embodiments or limit scope of the claims. Embodiments may perform additional operations, fewer operations, operations in a different order, operations in parallel, and some operations differently. For instance, referring to FIG. 3, the operations for detecting a behavior performed by an avatar and determining if the behavior is one of a plurality of predefined behaviors may occur in parallel.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

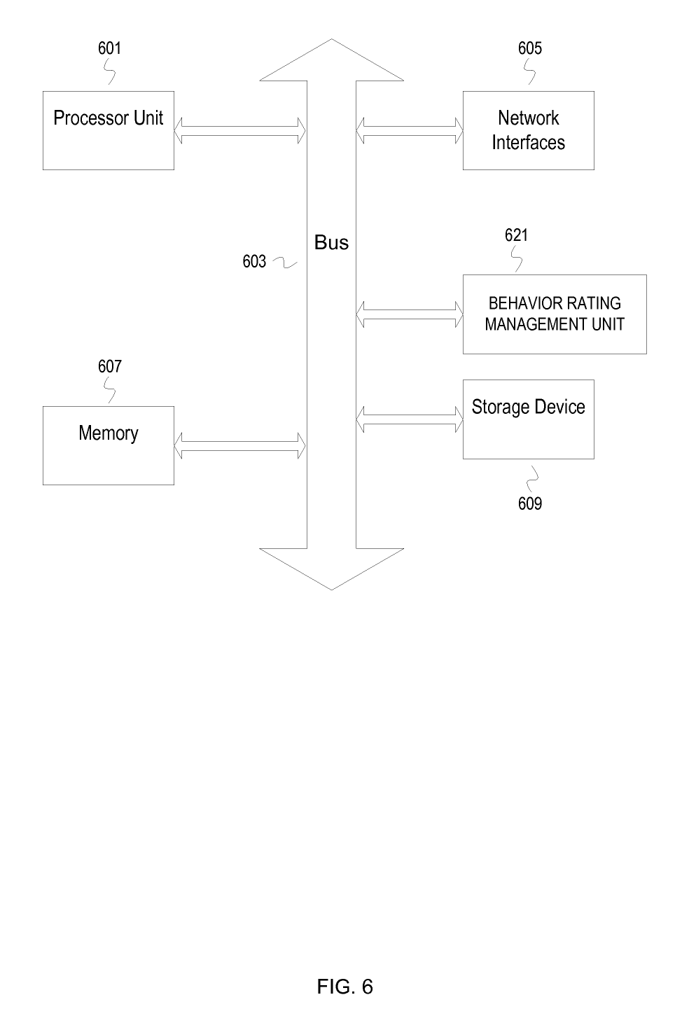

FIG. 6 depicts an example computer system. A computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport®, InfiniBand®, NuBus, etc.), a network interface 605 (e.g., an ATM interface, an Ethernet interface, a Frame Relay interface, SONET interface, wireless interface, etc.), and a storage device(s) 609 (e.g., optical storage, magnetic storage, etc.). The computer system also includes a behavior rating management unit 621 that detects that an avatar's behavior rating should be updated and updates the avatar's behavior rating. The behavior rating management unit 621 also determines if avatars should be allowed to access behavior rating restricted areas based on behavior ratings of the avatars. Any one of these functionalities may be partially (or entirely) implemented in hardware and/or on the processing unit 601. For example, the functionality may be implemented with an application specific integrated circuit, in logic implemented in the processing unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601, the storage device(s) 609, and the network interface 605 are coupled to the bus 603. Although illustrated as being coupled to the bus 603, the memory 607 may be coupled to the processor unit 601.

While the embodiments are described with reference to various implementations and exploitations, it will be understood that these embodiments are illustrative and that the scope of the inventive subject matter is not limited to them. In general, techniques for managing behavior ratings for avatars in a virtual universe as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1-20. (canceled)

21. A method of culturally aware behavior rating in a virtual universe, the method comprising:
accessing user characteristic data of a user associated with an avatar in the virtual universe responsive to an indication that a behavior of the avatar may impact a behavior rating of the user in the virtual universe, wherein the user characteristic data at least indicates a country;
determining whether the behavior of the avatar is indicated as acceptable for a culture of the country; and
modifying a behavior rating associated with the user in accordance with said determining whether the behavior of the avatar is indicated as acceptable for the culture of the country.

22. The method of claim 21 further comprising receiving the indication that the behavior of the avatar may impact the behavior rating of the user in the virtual universe.

23. The method of claim 22 wherein said receiving the indication that the behavior of the avatar may impact the behavior rating of the user in the virtual universe is responsive to input of the second indication by another user of the virtual universe.

24. The method of claim 22 further comprising the virtual universe detecting the behavior of the avatar and generating the indication that the behavior of the avatar may impact the behavior rating of the user in the virtual universe.

25. The method of claim 21, wherein said modifying the behavior rating associated with the user comprises reducing the behavior rating of the user responsive to determining that the behavior of the avatar is indicated as unacceptable for the culture of the country indicated in the user characteristic data.

26. The method of claim 25 further comprising:
accessing second user characteristic data of a second user associated with a second avatar in the virtual universe responsive to an indication that a behavior of the second avatar may impact a behavior rating of the second user in the virtual universe, wherein the second user characteristic data at least indicates a second country and the behavior of the second avatar is the same as the behavior of the avatar;
determining that the behavior of the second avatar is indicated as acceptable for a culture of the second country; and
maintaining the behavior rating of the second user based on said determining that the behavior of the second avatar is indicated as acceptable for the culture of the second country.

27. The method of claim 21 further comprising:
determining that the modified behavior rating exceeds a misbehavior threshold; and
restricting activity of the user with respect to the virtual universe.

28. A computer program product for culturally aware behavior rating in a virtual universe, the computer program product comprising:
a computer readable storage medium having computer usable program code embodied therewith, the computer usable program code comprising a computer usable program code configured to,
access user characteristic data of a user associated with an avatar in the virtual universe responsive to an indication that a behavior of the avatar may impact a behavior rating of the user in the virtual universe, wherein the user characteristic data at least indicates a country;
determine whether the behavior of the avatar is indicated as acceptable for a culture of the country; and
modify a behavior rating associated with the user in accordance with determining whether the behavior of the avatar is indicated as acceptable for the culture of the country.

29. The computer program product of claim 28, wherein the computer usable program code is further configured to receive the indication that the behavior of the avatar may impact the behavior rating of the user in the virtual universe.

30. The computer program product of claim 29, wherein the computer usable program code configured to receive the indication that the behavior of the avatar may impact the behavior rating of the user in the virtual universe is responsive to input of the second indication by another user of the virtual universe.

31. The computer program product of claim 29, wherein the computer usable program code is further configured to detect the behavior of the avatar and generate the indication that the behavior of the avatar may impact the behavior rating of the user in the virtual universe.

32. The computer program product of claim 28, wherein the computer usable program code configured to modify the behavior rating associated with the user comprises the computer usable program code configured to reduce the behavior rating of the user responsive to determining that the behavior of the avatar is indicated as unacceptable for the culture of the country indicated in the user characteristic data.

33. The computer program product of claim 32, wherein the computer usable program code is further configured to:
access second user characteristic data of a second user associated with a second avatar in the virtual universe responsive to an indication that a behavior of the second avatar may impact a behavior rating of the second user in the virtual universe, wherein the second user characteristic data at least indicates a second country and the behavior of the second avatar is the same as the behavior of the avatar;
determine that the behavior of the second avatar is indicated as acceptable for a culture of the second country; and
maintain the behavior rating of the second user based on determining that the behavior of the second avatar is indicated as acceptable for the culture of the second country.

34. The computer program product of claim 28, wherein the computer usable program code is further configured to:
determine that the modified behavior rating exceeds a misbehavior threshold; and
restrict activity of the user with respect to the virtual universe.

35. An apparatus for culturally aware behavior rating in a virtual universe, the apparatus comprising:
a processor;
a network interface; and
a behavior rating management unit operable to,
access user characteristic data of a user associated with an avatar in the virtual universe responsive to an indication that a behavior of the avatar may impact a behavior rating of the user in the virtual universe, wherein the user characteristic data at least indicates a country;
determine whether the behavior of the avatar is indicated as acceptable for a culture of the country; and
modify a behavior rating associated with the user in accordance with determining whether the behavior of the avatar is indicated as acceptable for the culture of the country.

36. The apparatus of claim 28, wherein the behavior rating management unit is further operable to receive the indication that the behavior of the avatar may impact the behavior rating of the user in the virtual universe.

37. The apparatus of claim 29, wherein the behavior rating management unit being operable to receive the indication that the behavior of the avatar may impact the behavior rating of the user in the virtual universe is responsive to input of the second indication by another user of the virtual universe.

38. The apparatus of claim 29, wherein the behavior rating management unit is further operable to detect the behavior of the avatar and generate the indication that the behavior of the avatar may impact the behavior rating of the user in the virtual universe.

39. The apparatus of claim 28, wherein the behavior rating management unit being operable to modify the behavior rating associated with the user comprises the behavior rating management unit being operable to reduce the behavior rating of the user responsive to determining that the behavior of the avatar is indicated as unacceptable for the culture of the country indicated in the user characteristic data.

40. The apparatus of claim 32, wherein the behavior rating management unit is further operable to:
access second user characteristic data of a second user associated with a second avatar in the virtual universe responsive to an indication that a behavior of the second avatar may impact a behavior rating of the second user in the virtual universe, wherein the second user characteristic data at least indicates a second country and the behavior of the second avatar is the same as the behavior of the avatar;
determine that the behavior of the second avatar is indicated as acceptable for a culture of the second country; and
maintain the behavior rating of the second user based on determining that the behavior of the second avatar is indicated as acceptable for the culture of the second country.
